(19) United States
(12) Patent Application Publication
(10) Pub. No.: US 2017/0048855 A1
(43) Pub. Date: Feb. 16, 2017

(54) Managing Service Acquisition on a Wireless Communication Device

(71) Applicant: QUALCOMM Incorporated, San Diego, CA (US)

(72) Inventors: Vinay Garg, San Diego, CA (US); Shivank Nayak, San Diego, CA (US); Brian Patrick A'Hearn, San Diego, CA (US)

(21) Appl. No.: 14/824,285

(22) Filed: Aug. 12, 2015

(51) Int. Cl. H04W 72/04; H04L 12/26

(52) U.S. Cl. CPC H04W 72/0453; H04L 43/16; H04W 72/10

(57) ABSTRACT

Methods and devices are disclosed for enabling improved service acquisition on at least one SIM of a wireless communication device. After a first SIM has lost service, the wireless communication device may identify, in a first radio access technology (RAT) priority list configured to support the first SIM, a highest ranked radio access technology. The wireless communication device may search a local wireless environment for networks associated with the identified radio access technology, and determine whether any network associated with the identified radio access technology is available, Upon determining that the no network associated with the identified radio access technology is available, the wireless communication device may update the RAT priority list associated with the first SIM.

### BACKGROUND

Wireless communication devices may employ a variety of methods for achieving a network connection after initial power up or out-of-service conditions on the device. For example, a wireless communication device may scan the local wireless environment to detect radio frequencies corresponding to networks using a particular radio access technology, and select suitable cells in those networks based on any of a number of prioritization factors (e.g., default priorities established by an operator, user preferences, etc.) In a typical arrangement, a wireless communication device may store a default list of supported radio access technologies, a list of networks set by an operator, a list of frequency bands supported in each radio access technology, and a list of channels within each supported band.

Multi-subscriber identification module (SIM) wireless communication devices have become increasing popular because of their flexibility in service options and other features. One example multi-SIM wireless communication device, a multi-SIM multi-active (MSMA) device, allows simultaneous active connections with the networks corresponding to more than one SIM using separate transmit/receive chains associated with each SIM. Dual-SIM dual-active (DSDA) communication devices are an example of a type of MSMA communication device. Another example multi-SIM wireless communication device, a multi-SIM multi-standby (MSMS) device, typically provides for a “standby” mode (i.e., idle mode) in which services associated with either SIM may originate or terminate a communication (e.g., a voice call or data call) using a shared transmit/receive chain (also referred to as a shared radio frequency (RF) resource). An example of a MSMS device is a dual-SIM dual-standby (DSDS) device.

In various wireless communication devices, each modem stack associated with a SIM may access information that has been provisioned by an operator (e.g., a manufacturer, network provider, etc.) and may independently perform idle mode tasks required for service acquisition. Consequently, each modem stack associated with a SIM may separately perform processes including scanning the local wireless environment on frequencies (e.g., previously acquired broadcast channels and/or other frequencies in supported bands) associated with a highest priority radio access technology. Such processes also include reading system information, including network identification, on broadcast channels. If no networks are available for the highest priority radio access technology, these operations may be sequentially repeated for one or more next highest priority radio access technologies until at least one network is acquired.

### SUMMARY

Systems, methods, and devices of various embodiments may enable a wireless communication device configured to use at least a first SIM associated with a radio frequency (RF) resource to manage service acquisition by detecting an out-of-service condition on the first SIM, identifying, in a first radio access technology (RAT) priority list corresponding to the first SIM, a highest ranked radio access technology configured to support the first SIM, searching a local wireless environment for networks associated with the identified radio access technology, determining whether any network associated with the identified radio access technology is available, and updating the first RAT priority list in response to determining that no network associated with the identified radio access technology is available.

Some embodiments may further include creating the first RAT priority list based on a default radio access technology (default RAT) priority list associated with the first SIM. In some embodiments, the default RAT list may be pre-configured in the wireless communication device by an operator.

In some embodiments, searching a local wireless environment for networks associated with the identified radio access technology may include scanning frequencies allocated to the identified radio access technology for channels that satisfy a signal strength threshold, and determining whether any network associated with the identified radio access technology is available may be based on system information read from channels that satisfy the signal strength threshold.

In some embodiments, updating the first RAT priority list may include incrementing a counter associated with the identified radio access technology, determining whether a current value of the counter is greater than a threshold value corresponding to the identified radio access technology, and decreasing a priority ranking of the identified radio access technology in the first RAT priority list in response to determining that the current value of the counter is greater than a threshold value corresponding to the identified radio access technology. In some embodiments, the threshold value corresponding to the identified radio access technology is set by the wireless communication device based on signal conditions in the local wireless environment. In some embodiments, decreasing the priority ranking of the identified radio access technology in the first RAT priority list may include one of lowering a priority ranking of the identified radio access technology by a preset amount, and changing the priority ranking of the identified radio access technology to a preset last position in the RAT priority list.

Some embodiments may further include determining whether the wireless communication device is configured with at least a second SIM, accessing a second RAT priority list corresponding to the second SIM in response to determining that the wireless communication device is configured with at least a second SIM, determining whether the identified radio access technology is listed in the second RAT priority list, and updating the second RAT priority list in response to determining that the identified radio access technology is listed in the second RAT priority list. Some embodiments may further include, in response to determining that at least one network associated with the identified radio access technology is available, determining whether a mode selection setting for the first SIM requires searching the local wireless environment for networks associated with at least one additional radio access technology, and selecting and registering for service in one of the at least one network available for the identified radio access technology in response to determining that the mode selection setting of the first SIM does not require searching the local wireless environment for networks associated with at least one additional radio access technology. In some embodiments, registering for service may enable communications using a modem stack associated with the first SIM.

Some embodiments may further include retrieving information from a first default radio access technology (default RAT) priority list associated with the first SIM, determining whether a default priority ranking of the identified radio access technology is higher than a priority ranking of the identified radio access technology in the first RAT priority list, and replacing a priority ranking of the identified radio access technology in the first RAT priority list with the default priority ranking of the identified radio access technology in response to determining that the default priority ranking of the identified radio access technology is higher than the priority ranking of the identified radio access technology.

Some embodiments may further include, in response to determining that the mode selection setting of the first SIM requires searching the local wireless environment for networks associated with at least one additional radio access technology, performing the required searching of the local wireless environment, reporting the available at least one network associated with the identified radio access technology in combination with any available networks associated with the at least one additional radio access technology, and receiving input to select and register for service in a reported network.

Some embodiments may further include retrieving information from the first default RAT list, determining whether a default priority ranking of any radio access technology associated with a reported network is higher than a corresponding priority ranking in the first RAT priority list, and replacing the corresponding priority ranking in the first RAT priority list with the default priority ranking of that radio access technology in response to determining that the default priority ranking of any radio access technology associated with a reported network is higher than the corresponding priority ranking in the first RAT priority list.

Various embodiments include a wireless communication device configured to use at least a first SIM associated with an RF resource, and including a processor configured with processor-executable instructions to perform operations of the methods described above. Various embodiments also include a non-transitory processor-readable medium on which is stored processor-executable instructions configured to cause a processor of a wireless communication device to perform operations of the methods described above. Various embodiments include a wireless communication device having means for performing functions of the methods described above.

### BRIEF DESCRIPTION OF THE DRAWINGS

The accompanying drawings, which are incorporated herein and constitute part of this specification, illustrate exemplary embodiments, and together with the general and detailed descriptions, serve to explain the features of the claims.

FIG. 1 is a communication system block diagram of a network suitable for use with various embodiments.

FIG. 2 is a block diagram illustrating a wireless communication device according to various embodiments.

FIG. 3 is a block diagram illustrating an example protocol layer in a wireless communication device according to various embodiments.

FIGS. 4A-4C are process flow diagrams illustrating a method for improving service acquisition in an example wireless communication device according to various embodiments.

FIG. 5 is a component diagram of an example wireless communication device suitable for use with various embodiments.

FIG. 6 is a component diagram of another example wireless communication device suitable for use with various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

Various embodiments include methods implemented on wireless communication device for managing service acquisition by keeping track of radio access technologies (RATs) that are not found during service acquisition searches in a particular area so that such RATs are not searched in subsequent service acquisition searches, including service acquisition services by other subscriptions on multi-SIM wireless communication devices.

The terms “wireless communication device” and “wireless communications device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “SIM,” “SIM card,” and “subscriber identification module” are used interchangeably to mean a memory that may be an integrated circuit or embedded into a removable card, which stores an International Mobile Subscriber Identity (IMSI), related key, and/or other information used to identify and/or authenticate a wireless communication device on a network. The term “SIM” may also be used as shorthand reference to a communication network associated with a particular SIM, since the information stored in a SIM enables the wireless communication device to establish a communication link with a particular network, thus the SIM and the communication network, as well as the services and subscriptions supported by that network, correlate to one another.

As used herein, the terms “multi-SIM wireless communication device,” “multi-SIM wireless communication device,” “dual-SIM wireless communication device,” “dual-SIM dual active device,” and “DSDA device” are used interchangeably to describe a wireless communication device that is configured with more than one SIM and is capable of independently handling communications with networks of all subscriptions.

As used herein, the terms “network,” “wireless network,” “cellular network,” and “public land mobile network” (PLMN) are used interchangeably to describe a wireless network of a carrier associated with a wireless communication device and/or subscription on a wireless communication device, and/or its roaming partners.

As used herein, the terms “channel,” “cell,” “frequency,” “BCCH carrier frequency,” “pilot signal,” and “carrier signal, are used interchangeably to describe a base frequency signal which a network broadcasts from a base transceiver station (BTS), radio base station (RBS), or node B in order to advertise its presence, operator identity, and other necessary initial information.

The terms “service acquisition” and “acquisition” when used herein with respect to a network or service on a network refers to performing idle mode functions including acquiring carrier frequencies/pilot signals associated with a SIM. Service acquisition (or acquisition) may involve scanning a list of previously acquired channels and/or scanning frequency bands to identify carrier frequencies exhibiting a received signal strength above a threshold signal strength. Acquisition may further include attempting to receive control channel information on the identified carrier frequencies, such as detecting a tone on a Frequency Correction Channel (FCCH), decoding a burst of a Synchronization Channel (SCH), and reading system information from a Broadcast Control Channel (BCCH).

Wireless communication networks (referred to simply as “wireless networks”) are widely deployed to provide various communication services such as voice, packet data, broadcast, messaging, and so on. Wireless networks may be capable of supporting communication for multiple users by sharing the available network resources. Such sharing of available network resources may be implemented by networks using one or more multiple-access wireless communications protocols, such as Time Division Multiple Access (TDMA), Code Division Multiple Access (CDMA), Time Division Multiple Access (TDMA), and Frequency Division Multiple Access (FDMA). These wireless networks may also utilize various radio technologies, including but not limited to Global System for Mobile Communications (GSM), Universal Mobile Telecommunications System (UMTS), CDMA2000, Advanced Mobile Phone Service (AMPS), General Packet Radio Services (GPRS), Long Term Evolution (LTE), High Data Rate (HDR) technology (e.g., 1×EV technology), etc.

In current mobile communications, wireless service carriers have standardized a number of techniques for selecting wireless communications systems and obtaining service therefrom in accordance with preferences of the subscriber's service provider/carrier. Service providers generally enable subscribers to access a network by providing provisioning information to subscriber devices. For clarity, various embodiments that are described for GSM-type and/or UMTS-type networks may be applied to networks using any other radio technology or protocol.

A wireless network (e.g., a public land mobile network (PLMN)) is a communications network established by a wireless service carrier/service provider. Mobile communication networks are cellular in that the networks consist of a number of cellular base stations deployed so that wireless communication devices can establish an acceptable communication link with at least one base station. The areas surrounding each base station within which wireless communication devices can establish a reliable communication like to the base station are referred to as “cells.” When there are several networks deployed in the same region, the cells of the various networks typically overlap. In typical wireless communications, a network is associated with one (and sometimes more) radio access technology, and operates on specific RF channels within frequency bands designated for the radio access technology.

By license or agreement the frequency bands assigned to different radio access technologies within an area do not overlap, thereby enabling customers to communicate with one network without radio interference from other networks. Similarly, the RF channels used by each base station of a network are allocated so that neighboring cells will not interfere with each other's radio communications. Each RF channel is generally identified by a unique number, for example, an absolute radio frequency channel number (ARFCN) in a GSM PLMN, or a UMTS Terrestrial Radio Access (UTRA) ARFCN (UARFCN) in a UMTS PLMN. Some networks/PLMNs include cells that support communications on multiple different multiple-access wireless communications protocols/radio access technologies.

An example GSM network may operate on any of a number of GSM bands (e.g., GSM 900, GSM 850, etc.), each of which cover multiple radio frequency (RF) channels identified by ARFCNs. The ARFCNs for various GSM bands are given in 3GPP Technical Specification (TS) 05.05, entitled “Digital cellular telecommunications system (Phase 2+); Radio transmission and reception (Release 1999).” Further, each GSM network typically operates on a specific set of RF channels in a specific GSM band. In describing various embodiments, the terms “channel,” “frequency,” and “ARFCN” may be used interchangeably and may refer to channels in GSM bands, and/or channels in other network bands (i.e., UARFCNs for UMTS networks, etc.).

A multi-SIM wireless communication device that supports two or more SIM cards may have a number of capabilities that provide convenience to a user, such as allowing different wireless carriers, plans, telephone numbers, billing accounts, etc. on one device. Developments in multi-SIM wireless communication device technology have led to a variety of different options for such devices. For example, an MSMA device allows multiple SIMs to remain active and accessible to the device. Thus, in an MSMA device the SIMs may simultaneously operate in any of a variety of modes, such as active/connected mode (i.e., transmitting and/or receiving data), idle mode, etc. Other multi-SIM wireless communication devices may be configured to operate more than two SIMs in simultaneous active connections, such as by providing a separate transceiver for each of at least three SIMs.

A wireless communication device manufacturer and/or system operator may pre-configure a single-SIM or multi-SIM wireless communication device with various types of information to enable communications on multiple wireless networks. Such information may include, for example, a default list of supported radio access technologies (referred to as a default radio access technology (default RAT) list) along with frequency bands for each such radio access technology for acquiring service on one or more SIM. The default RAT list may be pre-configured by an original operator (e.g., network operator, manufacturer, distributor, etc.), and the list may specify an order or priority in which the wireless communication device may attempt to scan for a system after initial power-on, independent of the service provider. For example, while some wireless communication devices may be distributed by the same operator that provisioned a SIM, other wireless communication devices may be distributed by a first operator and used with at least one SIM provisioned by another operator (e.g., a service provider, etc.), such as open market/unlocked devices. Typically, the default RAT list stored in each SIM may be may be uploaded to non-volatile memory of the wireless communication device. In a multi-SIM wireless communication device, a separate default RAT list may be separately provided for each SIM.

Each SIM of the wireless communication device may be provisioned with data files that identify networks in which the wireless communication device having the SIM is allowed to receive service, and the one or more radio access technologies associated with each such network. A network may be identified by a PLMN identifier, and may be a home PLMN or a roaming partner PLMN. Further, the networks may have a preference order set forth by the system operator or the user, depending on the source of the data file. Using such data files, service acquisition may start by searching a highest priority radio access technology in the default RAT list, and traversing a ranking order of networks identified in at least one of the data files to find a match. In a multi-SIM wireless communication device, each SIM may be associated with a separate default RAT list that has been pre-configured by the operator. Alternatively, each SIM may be associated with the same default RAT list and/or access a separate copy of a single default RAT list pre-configured by the operator. Further, the data files stored on each SIM may list the same or different network identifiers and corresponding radio access technologies.

In operation, once powered on or upon recovering service, a conventional wireless communication device (or modem stack associated with a SIM of a conventional multi-SIM wireless communication device) performs a search for signals from networks for a particular radio access technology. For example, the wireless communication device may find GSM networks by scanning and measuring signal strength on the channels of each frequency band used by GSM networks, and may identify those channels that exceed a threshold signal strength as being potential BCCH carriers. To determine whether a strong channel is a BCCH carrier, the wireless communication device may look to receive a frequency correction burst sent on a Frequency Correction Channel (FCCH). Upon detecting that a channel is a BCCH carrier, the wireless communication device typically tunes to the carrier frequency. On this frequency, the wireless communication device may read a Synchronization Channel (SCH) to obtain a base station identity code (BSIC), followed by reading the BCCH to obtain system/network information (e.g., a PLMN identifier). In this manner, the wireless communication device may identify available GSM cells in its vicinity.

A conventional wireless communication device may select a network according to one of at least two modes: automatic mode and manual mode.

In automatic mode, the wireless communication device automatically chooses a network for searching from among those acquired in a particular radio access technology (i.e., highest priority in a default RAT list) according to a predetermined order. The predetermined order may be specified, for example, according to networks listed in data files provided by an operator and/or a user (for example, an Home PLMN (HPLMN) Selector file, Operator controlled PLMN Selector file, and/or User controlled PLMN Selector file).

In manual mode, the wireless communication device performs a search to find all networks in the vicinity of the device (i.e., a manual PLMN search), which may be limited to one or more particular radio access technology (e.g., first one or several highest priority in a default RAT list). In this manner, the wireless communication device may avoid prolonged scans across the entire air interface. Following a manual PLMN search, the wireless communication device may present to the user a list containing all found networks associated with the one or more particular radio access technology from which the user may select (e.g., by inputting a selection on a user interface).

In various embodiments, service acquisition procedures on a single-SIM or multi-SIM wireless communication device may be improved by creating a radio access technology (RAT) priority list that may be updated or changed based on operating experience (and thus may be considered to be a dynamic list). The RAT priority list may initially reflect the default RAT list, but uses acquisition history to update the priorities of radio access technology entries. Following service loss on a subscription associated with a SIM, the wireless communication device may attempt to acquire networks in various supported radio access technologies according to the ranking/order set forth in the RAT priority list for that SIM. If the wireless communication device is unable to find any network associated with the highest priority radio access technology, a counter for that radio access technology may be incremented. If a threshold number of acquisition attempts following out-of-service conditions on any SIM is reached, the priority of that radio access technology may be lowered in all RAT priority lists that include that radio access technology. The priority of that radio access technology in each RAT priority list may be restored to that of the default RAT list after a network associated with that radio access technology is acquired on any SIM.

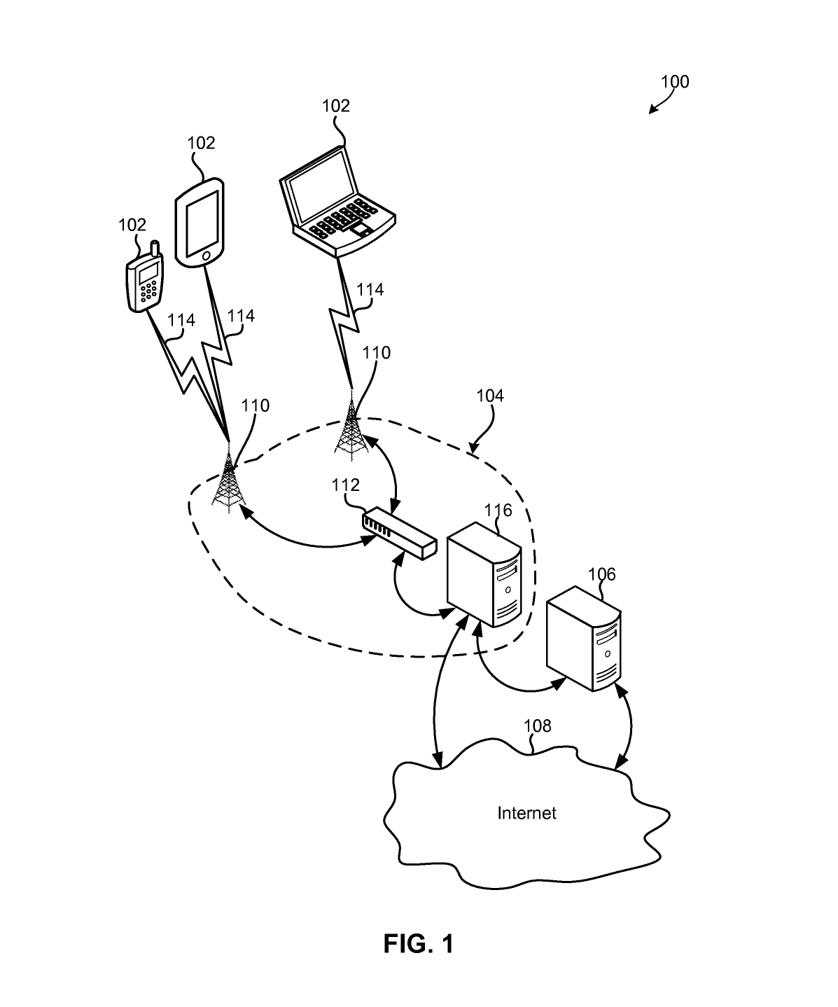

Various embodiments may be implemented within a variety of communication systems, such as the example communication system 100 illustrated in FIG. 1. The communication system 100 may include one or more wireless communication devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 includes a plurality of cell base stations 110 coupled to a network operations center 112, which operates to connect voice and data calls between the wireless communication devices 102 (e.g., tablets, laptops, cellular phones, etc.) and other network destinations, such as via telephone land lines (e.g., a plain old telephone system (POTS) network, not shown) and the Internet 108. The telephone network 104 may also include one or more servers 116 coupled to or within the network operations center 112 that provide a connection to the Internet 108 and/or to the network servers 106. Communications between the wireless communication devices 102 and the telephone network 104 may be accomplished via two-way wireless communication links 114, such as GSM, UMTS, EDGE, 4G, 3G, CDMA, TDMA, LTE, and/or other communication technologies.

Some or all of the wireless communication devices 102 may be configured with multi-mode capabilities and may include multiple transceivers for communicating with different wireless networks over different wireless links/radio access technologies. For example, the wireless communication device 102 may be configured to communicate over multiple wireless data networks on different subscriptions, such as in a multi-SIM wireless communication device.

For clarity, while the techniques and embodiments may be described herein with respect to at least one GSM subscription and/or WCDMA/UMTS subscription, the method according to various embodiments may be extended to subscriptions on other radio access networks (e.g., LTE, EV-DO, TD-SCDMA, CDMA2000, etc.).

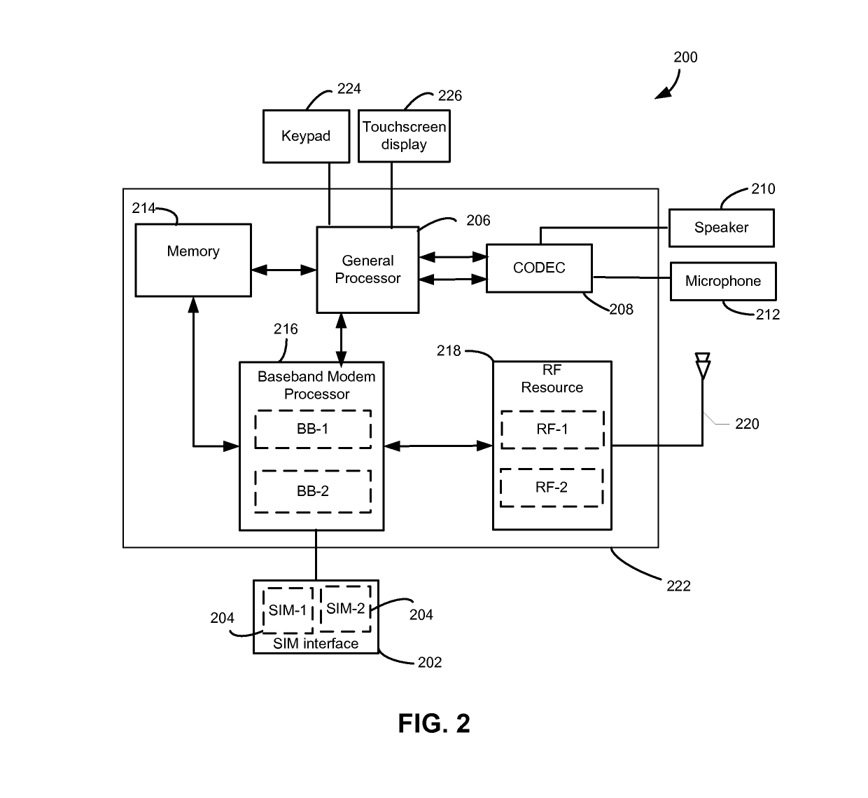

FIG. 2 is a functional block diagram of an example wireless communication device 200 that is suitable for implementing various embodiments. According to various embodiments, the wireless communication device 200 may be similar to one or more of the wireless communication devices 102 described with reference to FIG. 1. With reference to FIGS. 1-2, in various embodiments, the wireless communication device 200 may be a single-SIM device. In other embodiments, the wireless communication device 200 may be a multi-SIM wireless communication device, such as a multi-SIM multi-active (MSMA) device, or a multi-SIM multi-standby (MSMS) device.

The wireless communication device 200 may include at least one SIM interface 202, which may receive at least one SIM 204 associated with a first subscription. In some embodiments, the at least one SIM interface 202 may receive at least a first SIM (SIM-1) associated with a first subscription, and a second SIM (SIM-2) associated with a second subscription. In some embodiments, the at least one SIM interface 202 may be implemented as multiple SIM interfaces 202, which each may receive at least a first SIM (SIM-1) associated with at least a first subscription.

A SIM in various embodiments may be a Universal Integrated Circuit Card (UICC) that is configured with SIM and/or Universal Mobile Telecommunications System Subscriber SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204 may have a CPU, ROM, RAM, EEPROM and I/O circuits. One or more SIM 204 used in various embodiments may contain user account information, an IMSI a set of SIM application toolkit (SAT) commands and storage space for phone book contacts. One or more SIM 204 may further store home identifiers (e.g., a System Identification Number (SID)/Network Identification Number (NID) pair, an HPLMN code, etc.) to indicate the SIM network operator provider. An Integrated Circuit Card Identity (ICCID) SIM serial number may be printed on one or more SIM 204 for identification.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory tangible computer readable storage medium that stores processor-executable instructions. For example, the instructions may include routing communication data relating to a subscription though a corresponding baseband-RF resource chain. The memory 214 may store operating system (OS), as well as user application software and executable instructions.

The general-purpose processor 206 and the memory 214 may each be coupled to at least one baseband-modem processor 216. Each SIM 204 in the wireless communication device 200 may be associated with a baseband-RF resource chain that includes at least one baseband-modem processor 216 and at least one RF resource 218. In some multi-SIM embodiments, the wireless communication device 200 may be a DSDS device, with two SIMs 204 sharing a single baseband-RF resource chain that includes the baseband-modem processor 216 and the RF resource 218. The shared baseband-RF resource chain may include, for each of the first and second SIMs, separate baseband-modem processor 216 functionality (e.g., BB-1 and BB-2). In some multi-SIM embodiments, the wireless communication device 200 may be a DSDA device, with each of the two SIMs 204 associated with a baseband-RF resource chain that includes separate baseband-modem processor 216 functionality (e.g., BB-1 and BB-2) and separate RF resource 218 functionality (e.g., RF-1 and RF-2).

In various embodiments, the at least one RF resource 218 may be coupled to at least one antenna 220. The RF resource 218 may perform, either with shared functionality or separate functionality (e.g., RF-1, RF-2), the transmit/receive functions for the wireless services associated with each SIM 204 of the wireless communication device 200. The RF resource 218 may implement separate transmit and receive functionalities or may include a transceiver that combines transmitter and receiver functions.

In particular embodiments, the general-purpose processor 206, memory 214, baseband-modem processor 216, and RF resource 218 may be included in a system-on-chip device 222. The one or more SIM 204 and corresponding interface(s) 202 may be external to the system-on-chip device 222. Further, various input and output devices may be coupled to components of the system-on-chip device 222, such as interfaces or controllers. Example user input components suitable for use in the wireless communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between various software modules and functions in the wireless communication device 200 to enable communication between them, as is known in the art.

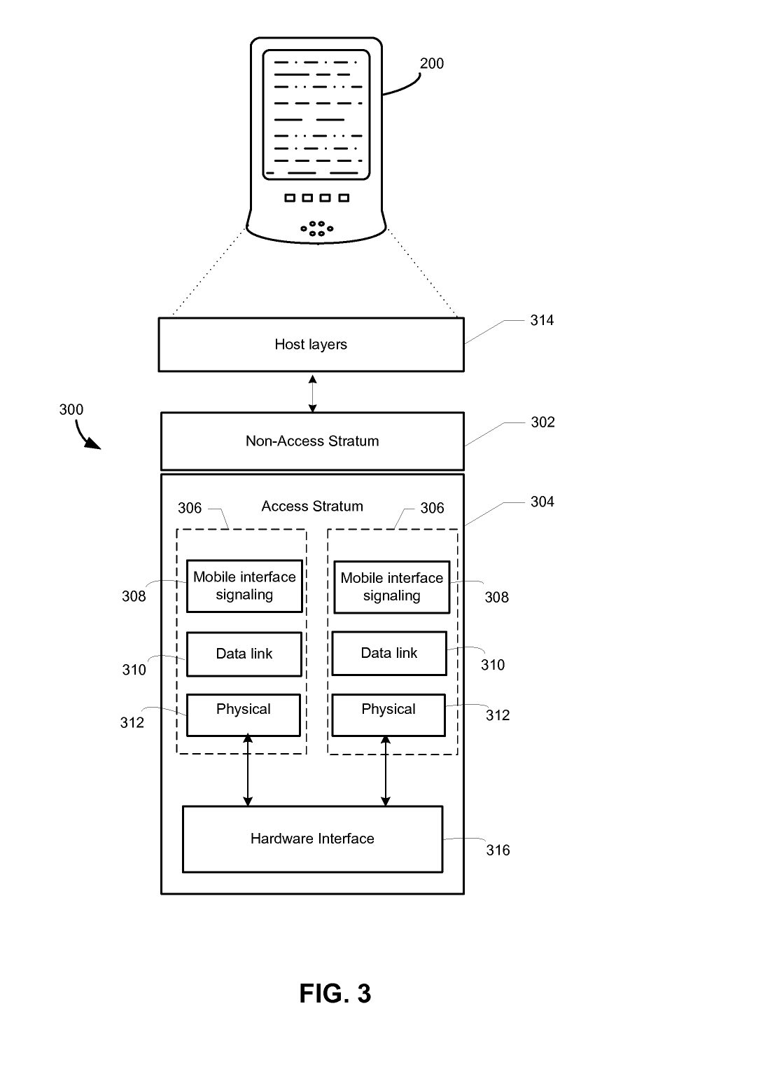

FIG. 3 illustrates a software architecture 300 suitable for implementing various embodiments. With reference to FIGS. 1-3, the wireless communication device 200 may use a layered software architecture 300 to communicate over access networks associated with one or more SIMs. The software architecture 300 may be distributed among one or more processors, such as the baseband-modem processor 216. The software architecture 300 may also include a Non-Access Stratum (NAS) 302 and an Access Stratum (AS) 304. The NAS 302 may include functions and protocols to support traffic and signaling between one or more SIM 204 of the wireless communication device 200 (e.g., first SIM/SIM-1 and/or second SIM/SIM-2) and the respective one or more core networks. The AS 304 may include functions and protocols that support communication between the SIM(s) (e.g., first SIM/SIM-1 and/or second SIM/SIM-2) and entities of the respective access network(s) (such as a mobile switching center (MSC) if in a GSM network).

In various embodiments, the AS 304 may include at least one protocol stack 306. In some embodiments, as shown in software architecture 300, the wireless communication device 200 may be a multi-SIM wireless communication device, with the AS 304 including multiple protocol stacks 306, each of which is associated with a different SIM. For example, in a dual-SIM device, the AS 304 may include two protocol stacks 306, which may be respectively associated with the first SIM/SIM-1 and the second SIM/SIM-2. In some embodiments, the wireless communication device 200 may be a single-SIM device, and the AS 304 may include a single protocol stack 306 (not shown). Although described below with reference to GSM-type communication layers, protocol stack(s) 306 may support any of variety of standards and protocols for wireless communications.

In various embodiments, the protocol stack(s) 306 may be implemented to allow modem operation using information provisioned on one or more SIM. Therefore, a protocol stack that may be executed by a baseband modem processor (e.g., 216) is interchangeably referred to herein as a modem stack.

The protocol stack(s) 306 may include mobile interface signaling layer(s) 308, which may be implementations of Layer 3 of a GSM signaling protocol (equivalent to radio resource control layer in implementation of UMTS signaling protocol Layer 3). Further, the mobile interface signaling layer(s) 308 may include at least one sublayer (not shown). Sublayers may include, but are not limited to, connection management (CM) sublayers that provide call management for circuit-switched communications, mobility management (MM) sublayers that may support the mobility of user devices (e.g., location update procedures, IMSI attach/detach etc.), and radio resource management (RR) sublayers that may oversee the establishment of links between the wireless communication device 200 and associated access networks, including management of the frequency spectrum, channel assignment and handover, power-level control, and signal measurements. In various embodiments, the NAS 302 and RR sublayers may perform various functions to search for wireless networks.

Residing below the mobile interface signaling layer(s) 308, the protocol stack(s) 306 may also include data link layer(s) 310, which may be part of Layer 2 in a GSM signaling protocol. The data link layer(s) 310 may provide functions to handle incoming and outgoing data across the network, such as dividing output data into data frames and analyzing incoming data to ensure the data has been successfully received. In some embodiments, each data link layer 310 may contain various sub-layers (e.g., media access control (MAC) and logical link control (LLC) layers (not shown)). Residing below the data link layer(s) 310, the protocol stack(s) 306 may also include physical layer(s) 312, which may establish connections over the air interface and manage network resources for the wireless communication device 200.

While the protocol stack(s) 306 provide functions to transmit data through physical media, the software architecture 300 may further include at least one host layer 314 to provide data transfer services to various applications in the wireless communication device 200. In some embodiments, application-specific functions provided by the at least one host layer 314 may provide an interface between the protocol stack(s) 306 and the general-purpose processor 206. In alternative embodiments, the protocol stack(s) 306 may include one or more higher logical layers (e.g., transport, session, presentation, application, etc.) that provide host layer functions. In some embodiments, the software architecture 300 may further include in the AS 304 a hardware interface 316 between the physical layer(s) 312 and the communication hardware (e.g., one or more RF resource).

In a multi-SIM wireless communication device, separate units of the baseband-modem processor of the multi-SIM wireless communication device may be implemented as separate structures or as separate logical units within the same structure, and may be configured to execute software including at least two protocol/modem stacks associated with at least two SIMs, respectively. The SIMs and associated modem stacks may be configured to support a variety of communication services that fulfill different user requirements. Further, a particular SIM may be provisioned with information to execute different signaling procedures for accessing a domain of the core network associated with these services and for handling data thereof.

In various embodiments in which a SIM supports more than one radio access technology, the radio resource may search for networks in each radio access technology separately. Each SIM may be associated with a given set of frequency bands that are assigned to networks configured to support that particular SIM. The set of frequency bands enabled for each SIM may be provided by the respective carriers for the SIMs of the wireless communication device, and may be different, the same, or overlapping.

For example, a search for GSM networks (i.e., PLMNs) may involve performing a power scan on frequency bands used by a GSM network supported by the SIM, identifying channels with received signal strengths above a threshold signal strength (e.g., a received signal strength indication (RSSI) of at least −85 dBm), and attempting acquisition of the identified channels. Acquisition of the identified channels may involve attempting to receive control channel information on the identified channels, for example, detecting a tone on a Frequency Correction Channel (FCCH), decoding a burst of a Synchronization Channel (SCH), and reading system information from a BCCH. A list of identified networks/PLMNs of the acquired GSM channels may be reported. In a similar process, a search for UMTS networks (i.e., PLMNs) may involve performing a power scan on frequency bands of a UMTS network supported by the SIM and identifying channels that exceed a threshold signal strength.

A PLMN search may further involve attempting acquisition on each identified channel by searching for a primary synchronization code (PSC) sequence sent on a primary synchronization channel (SCH) for each identified channel by correlating received samples with a locally generated PSC sequence at different time offsets. Acquisition may further involve using PSC sequences found to detect and ascertain the slot timing of a UMTS cell, determining a pattern of secondary synchronization code (SSC) sequences used by each UMTS cell for which the PSC has been detected, and determining frame timing and primary scrambling code used for each UMTS cell based on the detected SSC pattern for that cell. Using the PSC, a primary Common Control Physical Channel (P-CCPCH) may be detected, from which system information (e.g., a PLMN identifier) may be read. A list of PLMN identifiers of acquired UMTS channels may be reported.

In an MSMA device, network searches and selections are performed separately for subscriptions associated with each SIM. As a result, one subscription associated with one SIM (e.g., a first subscription/SIM) may be attempting acquisition of service, while another subscription associated with another SIM is camped on a suitable cell of that subscription's network. Attempting service acquisition may include, for example, searching for networks in the vicinity of the device. Further, in a MSMA device, multiple SIM modem stacks may simultaneously attempt to acquire service, including searching for networks using respective associated radio resources.

Each subscription associated with a SIM for which service has been lost may support multiple radio access technologies, and therefore may require searching/scanning frequencies of multiple radio access technologies, depending on the mode and radio access technology availability with respect to the default RAT list. As a result, the amount of time and power needed to complete service acquisition may be increased for each radio access technology in which no available networks are found. Moreover, additional delay and power use may be added for each switch to a different radio access technology that may be required to complete service acquisition.

In various embodiments, information about the unavailability of a radio access technology of a subscription associated with one SIM may be stored and used to update relative priorities of supported radio access technologies for future service acquisitions on any SIM. Specifically, a RAT priority list may be developed for each SIM of a wireless communication device based on the default RAT list stored in that SIM. In some embodiments, the RAT priority list for each SIM may be provided in a table or other data structure stored in non-volatile memory of the wireless communication device. In some embodiments, the RAT priority list(s) may be stored in other locations accessible to the wireless communication device processor, for example, on the corresponding SIM(s), in volatile memory, etc.

When the wireless communication device is in an out-of-service state on a particular network for a subscription associated with a SIM, the wireless communication device may access the corresponding RAT priority list, and attempt to acquire networks that are available for a particular radio access technology. That is, the wireless communication device may search for available networks associated with the highest ranked radio access technology for that SIM, and if none are found, for networks associated with the next highest ranked radio access technology, etc. In various embodiments, such searching in a particular radio access technology may involve scanning frequency bands/channels that correspond to that radio access technology.

Any network(s) that is acquired using that radio access technology may be reported to the non-access stratum and made available for network selection (e.g., using the automatic or manual mode as described) by a subscription. For example, network selection may involve selection of one of the reported networks associated with the particular radio access technology without further search.

If no network associated with the particular radio access technology is acquired, information indicating such lack of network coverage for that radio access technology may be stored by the wireless communication device. For example, in response to not acquiring any networks using a particular radio access technology, the wireless communication device may increment a counter that is associated with the particular radio access technology. In some embodiments, a single counter may be maintained for each supported radio access technology on the wireless communication device. That is, the same counter for each radio access technology may be incremented regardless of which SIM is associated with the service acquisition/scanning. In this manner, a cumulative tally of instances in which a particular radio access technology is unavailable is stored and accessible by all SIMs.

Each radio access technology for which there is a counter may also be associated with an unavailability threshold, which may be stored in non-volatile memory (e.g., 214) and/or on one or more SIM. In various embodiments, unavailability thresholds for supported radio access technologies may be provisioned by one or more operator and/or set by a user. In some embodiments, unavailability thresholds for supported radio access technologies may be sent over-the-air through an operator that is a service provider. In some embodiments, unavailability thresholds may be static, while in some embodiments unavailability thresholds may be dynamically set by the wireless communication device and/or an operator based on current signal conditions in the local wireless environment (e.g., signal/field strength, etc.).

In various embodiments, if the counter value for the particular radio access technology is greater than the unavailability threshold, the wireless communication device may consider that radio access technology to be unavailable at the current location, and the wireless communication device may lower the priority ranking of that radio access technology in the RAT priority list. In a multi-SIM wireless communication device, such an update to the RAT priority list may be applied for each SIM that supports communications on that radio access technology. By lowering the priority of radio access technologies determined to be unavailable, the wireless communication device may decrease the amount of time spent up searching for networks by skipping those radio access technologies when conducting the next search.

For example, a first SIM and a second SIM may each access a RAT priority list that specifies in order of descending priority ranking: LTE (or a particular type of LTE, such as LTE Advanced (LTE-A), LTE in unlicensed spectrum (LTE-U), etc.); WCDMA; GSM; and TD-SCDMA. For clarity, this order of RATs is provided as one example, but the various embodiments may be extended to any of a number of RATs and all potential orders that can be implemented in the RAT priority list.

Based on this RAT priority list, when an out-of-service state is detected on a SIM (e.g., the first SIM), service acquisition will start by searching first for networks associated with LTE (or the listed type of LTE) (i.e., the highest ranked radio access technology), and only if no suitable LTE channels are found will the wireless communication device begin searching for GSM network signals. Depending on whether previously-acquired LTE channel information is accessible, searching for LTE networks may require scanning all frequency bands allocated to LTE (or to the type of LTE) and measuring signal strength on each channel. As such, searching for LTE available networks may take up to 25 seconds.

In various embodiments, time spent searching for a network of an unavailable radio access technology may be avoided if the wireless communication device has already determined in a number of previous searches surpassing the unavailability threshold that no LTE channels are available. For example, once wireless communication device has failed to find signals from LTE networks a number of times that exceeds the unavailability threshold (i.e., the unavailability threshold for LTE has been reached), the wireless communication device may lower the ranking of LTE (or the type of LTE) from first (i.e., highest ranked) to last (i.e., lowest ranked), for example.

So updated, the updated RAT priority list for each SIM may specify in order of descending priority ranking: WCDMA; GSM; TD-SCDMA; and finally LTE. With the RAT priority list so updated, subsequent scans for service recovery may search for networks using LTE last, and thus only searching LTE if no networks are found for any of WCDMA, GSM, and TD-SCDMA, or only searching LTE if time permits (depending on whether in automatic or manual selection mode). As such, time that would be wasted searching for unavailable LTE networks may be saved and/or postponed until necessary.

Following the updates to the RAT priority lists, an out-of-service state may be detected again on the first SIM or may be detected on the second SIM. Based on the example updated RAT priority lists, the wireless communication device may again search LTE frequencies for available networks when the wireless communication device is (i) unable to acquire networks associated with WCDMA, GSM, or TD-SCDMA if using the automatic selection mode described, or (ii) required to output all available networks across each radio access technology supported by the out-of-service SIM as part of a comprehensive scan in manual selection mode. If any LTE networks are then acquired, the wireless communication device may again update the RAT priority lists associated with both SIMs to restore the ranking of LTE to its original priority in the default RAT list (e.g., highest priority in the example).

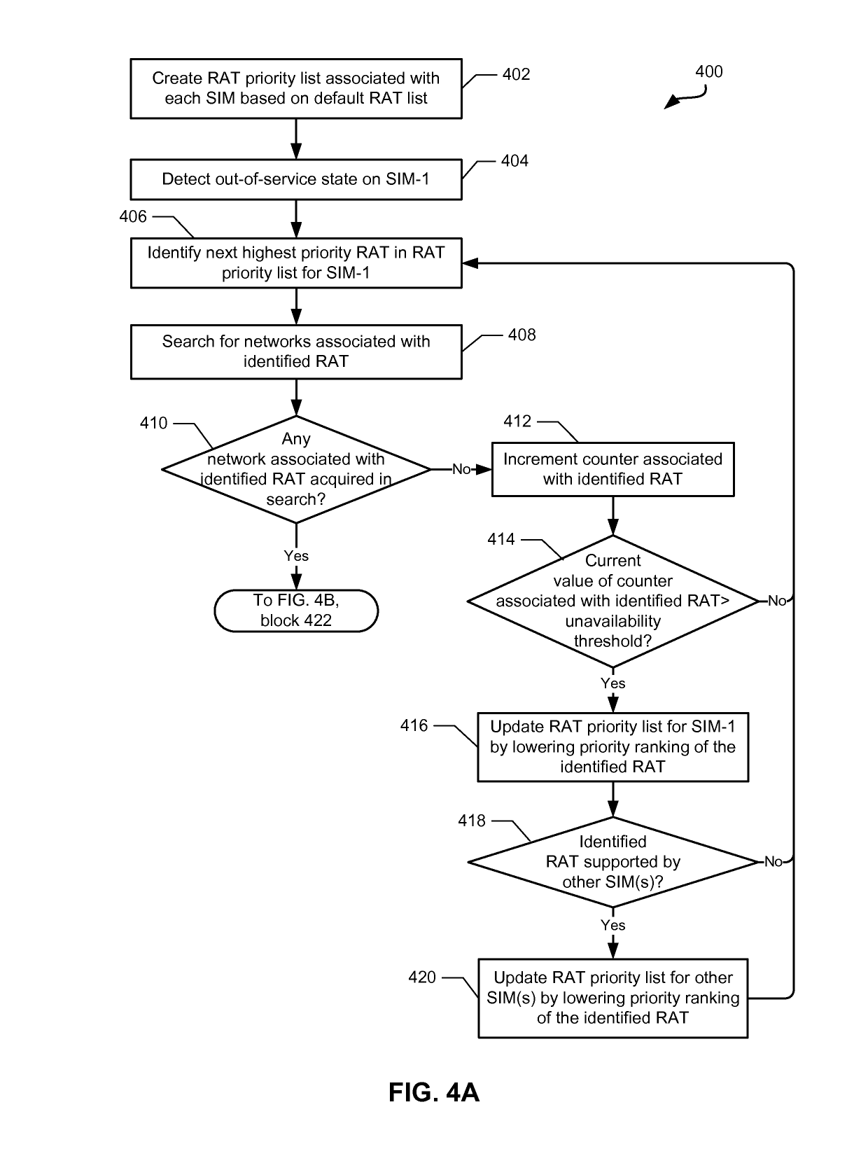

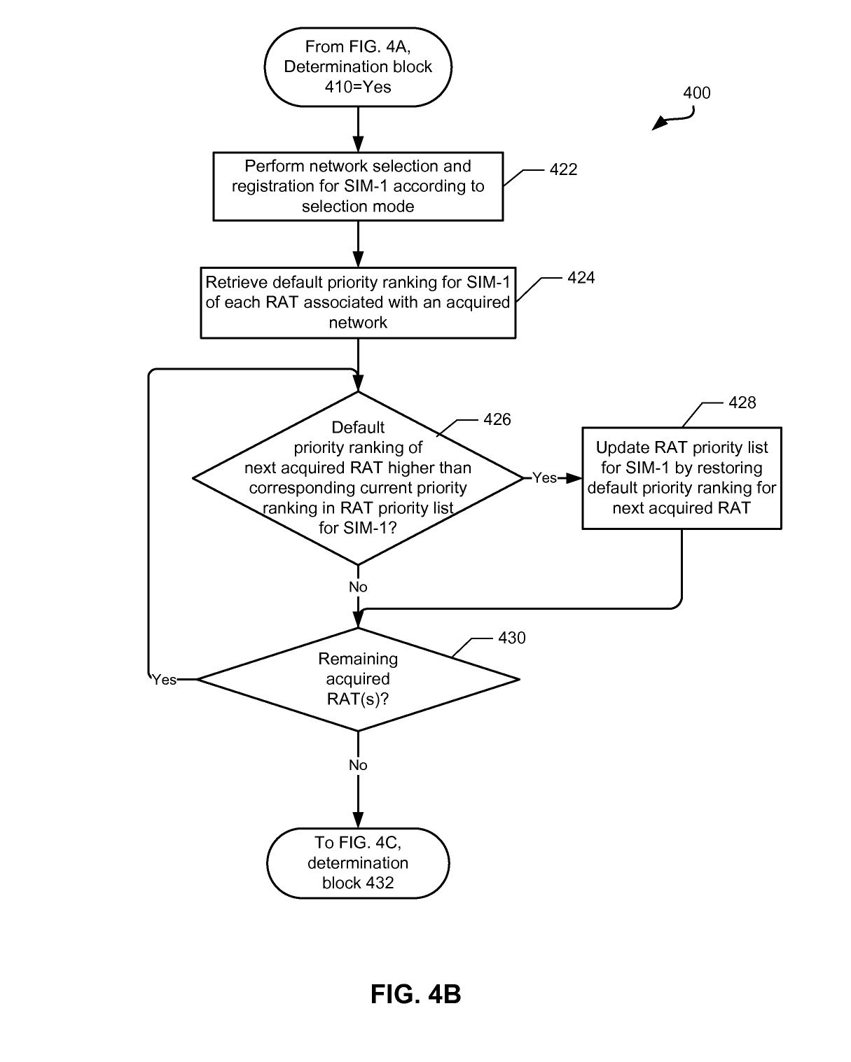

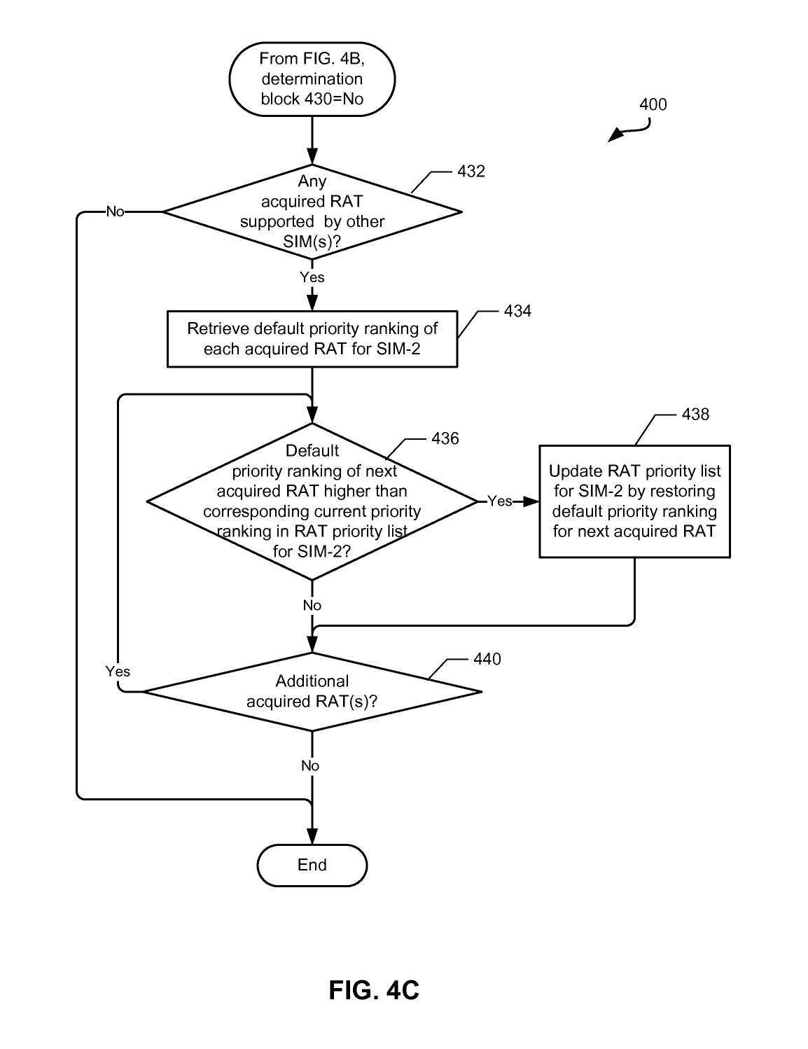

FIGS. 4A-4C illustrate a method 400 for improving efficiency in acquiring service on at least one SIM of a wireless communication device according to some embodiments. With reference to FIGS. 1-4C, in various embodiments, the operations of method 400 may be implemented by one or more processors of a wireless communication device (e.g., 102, 200), such as a general purpose processor (e.g., 206) and/or baseband-modem processor(s) (e.g., 216). In various embodiments, the operations of the method 400 may be implemented by a separate controller (not shown) that may be coupled to memory (e.g., 214) and to the one or more processor. The multi-SIM multi-standby device may be configured with a single shared RF resource (e.g., 218).

In block 402, the wireless communication device processor may create a RAT priority list associated with each SIM of the wireless communication device (e.g., one RAT priority list for a single-SIM device, two RAT priority lists for a dual-SIM device, etc.). In various embodiments, creating each RAT priority list may be based on the corresponding default RAT list, which may be stored for each SIM in non-volatile memory (e.g., 214) of the wireless communication device. For example, creating a RAT priority list for each of a first and second SIM may involve copying the contents of the default RAT list respectively associated with each SIM.

In block 404, the wireless communication device processor may detect an out-of-service state on at least the first SIM (“SIM-1”). For example, the out-of-service state may be the result of losing a connection to a serving network due to movement of the wireless communication device outside of coverage boundaries established by the service provider of the serving network. In another example, the first SIM may be in the out-of-service state due to the wireless communication device being reset or powered off, or due to an initial power-up of a newly configured device.

In block 406, the wireless communication device processor may identify a next highest priority RAT in the RAT priority list for the first SIM. In various embodiments, upon the first use of the RAT priority list created for the first SIM, the next highest priority radio access technology may be the radio access technology that is assigned the top/highest priority ranking in the RAT priority list and the corresponding default RAT list for the first SIM.

In block 408, the wireless communication device processor may search for networks associated with the identified (i.e., next highest priority) radio access technology. In some embodiments, such search may involve using the RF resource (e.g., 218) associated with the first SIM to perform an acquisition scan on frequencies assigned to the identified radio access technology, which may include using information about previously acquired carriers using the identified radio access technology.

In determination block 410, the wireless communication device processor may determine whether any network associated with the identified radio access technology was acquired in the search.

In response to determining that no network corresponding to the identified radio access technology was acquired in the search (i.e., determination block 410=“No”), the wireless communication device processor may increment a counter associated with the identified radio access technology in block 412.

In determination block 414, the wireless communication device processor may determine whether the current value of the counter associated with the identified radio access technology is greater than an unavailability threshold. As described, in some embodiments, the unavailability threshold may be a static threshold value that has been set by an operator or user. In some embodiments, the unavailability threshold may be a dynamic threshold value developed by the wireless communication device based on field conditions, or by the operator and updated over-the-air through transmissions to the wireless communication device.

In response to determining that the current value of the counter associated with the identified radio access technology is greater than the unavailability threshold (i.e., determination block 414=“Yes”), the wireless communication device processor may update the RAT priority list for the first SIM by lowering the priority ranking of the identified radio access technology in block 416.

In some embodiments, lowering the priority ranking of the identified radio access technology may involve changing the current priority ranking to a preset position, such as the last position in the RAT priority list. In some embodiments, the priority ranking of the identified radio access technology may be lowered by a preset number of positions. For example, updating the RAT priority list may be performed using (but not limited to) the equation: New ranking=Current ranking+2. Therefore, a radio access technology with a current first (i.e., highest) priority ranking would be lowered to a third priority ranking in the RAT priority list. In some embodiments, lowering the ranking of the identified radio access technology may be performed uniformly for any radio access technology. In some embodiments, each supported radio access technology may be associated with different settings for lowering rankings. For example, the identified radio access technology may be lowered by 2 if LTE, but lowered by 3 if GSM.

In determination block 418, the wireless communication device processor may determine whether the identified radio access technology is supported by any other SIM in the wireless communication device.

In response to determining that the identified radio access technology is supported by at least one other SIM (i.e., determination block 418=“Yes”), the wireless communication device processor may update a RAT priority list for each of the at least one other SIM by lowering the priority ranking of the identified radio access technology in block 420. In various embodiments, updating each RAT priority list may be performed in the same manner as described with respect to the RAT priority list for the first SIM.

In response to determining that the current value of the counter associated with the identified radio access technology is less than or equal to the unavailability threshold (i.e., determination block 414=“No”) or that the identified radio access technology is not supported by any other SIM in the wireless communication device (i.e., determination block 418=“No”), the wireless communication device processor may continue service acquisition for SIM-1 by identifying the next highest priority RAT in the RAT priority list for the first SIM (e.g., second, third, fourth, etc. priority ranking) in block 406.

In response to determining that at least one network corresponding to the identified radio access technology was acquired in the search for networks associated with the identified radio access technology (i.e., determination block 410 in FIG. 4A=“Yes”), the wireless communication device processor may perform network selection and registration for the first SIM according to an applicable selection mode setting in block 422 (FIG. 4B). That is, the wireless communication device processor may follow the procedures as described for network selection using either an automatic mode or a manual mode, followed by camping on a suitable cell of the selected network, and performing registration/attachment procedures in the selected network.

Depending on the selection mode, in some embodiments (e.g., some automatic mode configurations), the network selection performed in block 422 may be limited to only the networks acquired using the identified radio access technology in block 408 (FIG. 4A). In some embodiments (i.e., some manual mode configurations), the network selection performed in block 422 may involve searching for additional networks associated with at least one other radio access technology.

In block 424, the wireless communication device processor may retrieve a default priority ranking for the first SIM of each radio access technology associated with a network that was acquired in the search in block 408 (FIG. 4A) and/or in the network selection in block 422 (referred to as an acquired radio access technology). For example, such default priority rankings may be retrieved by accessing the default RAT list corresponding to the first SIM.

For each acquired radio access technology, the wireless communication device processor may compare the retrieved default priority ranking to the current ranking in the RAT priority list for the first SIM. That is, in determination block 426, the wireless communication device processor may determine whether the default priority ranking of a next acquired radio access technology is higher than a corresponding current priority ranking in the RAT priority list for the first SIM.

In response to determining that the default priority ranking of the next acquired radio access technology is higher than the corresponding current priority ranking in the RAT priority list for the first SIM (i.e., determination block 426=“Yes”), the wireless communication device processor may update the RAT priority list for the first SIM by restoring the default priority ranking for that radio access technology in block 428 (i.e., replacing the corresponding current priority ranking with the default priority ranking). In this manner, when a radio access technology that was previously lowered in priority ranking for the first SIM is subsequently acquired during service acquisition on the first SIM, the lowered ranking need not be continued since acquisition establishes that at least one network is available that is associated with the radio access technology.

In response to determining that the default priority ranking of the next acquired radio access technology is not higher than the corresponding current priority ranking in the RAT priority list for the first SIM (i.e., determination block 426=“No”), the wireless communication device processor may determine whether there are any remaining acquired radio access technologies in determination block 430.

So long as there is at least one remaining acquired radio access technology (i.e., determination block 430=“Yes”), the wireless communication device processor may continue to determine whether the default priority ranking of the next acquired radio access technology is higher than a corresponding current priority ranking in the RAT priority list for the first SIM in determination block 426.

In response to determining that there are no remaining acquired radio access technologies (i.e., determination block 430=“No”), the wireless communication device processor may determine whether any acquired radio access technology is also supported by another SIM in determination block 432 (FIG. 4C). For example, the second SIM (“SIM-2”) may also support communications on at least one radio access technology, some of which may be the same as the at least one acquired radio access technology for the first SIM. In response to determining that no acquired radio access technology is supported by the second SIM (i.e., determination block 432=“No”), the method 400 may end.

In response to determining that one or more acquired radio access technology is supported by the second SIM (i.e., determination block 432=“Yes”), the wireless communication device processor may retrieve a default priority ranking of each acquired radio access technology for the second SIM in block 434. For example, the wireless communication device processor may determine that, in addition to the first SIM, the second SIM supports communications using one or more acquired radio access technology and may retrieve default priority ranking(s) by accessing a corresponding default RAT list for the second SIM.

For each acquired radio access technology, the wireless communication device processor may compare the retrieved default priority ranking for the second SIM to the corresponding current ranking in the RAT priority list for the second SIM. That is, in determination block 436, the wireless communication device processor may determine whether the default priority ranking of a next acquired radio access technology is higher than the corresponding current priority ranking in the RAT priority list for the second SIM.

In response to determining that the default priority ranking of the next acquired radio access technology is higher than the priority ranking in the RAT priority list for the second SIM. (i.e., determination block 436=“Yes”), the wireless communication device processor may update the RAT priority list for the second SIM by restoring the respective default priority ranking for that radio access technology in block 438 (i.e., replacing the corresponding current priority ranking with the default priority ranking). In this manner, when a radio access technology that was previously lowered in priority ranking for another SIM (e.g., the second SIM) is subsequently acquired during service acquisition on the first SIM, the lowered ranking need not be continued since acquisition on any SIM establishes that at least one network is likely available that is associated with the radio access technology.

In response to determining that the default priority ranking of the next acquired radio access technology is not higher than corresponding priority ranking in the RAT priority list for the second SIM (i.e., determination block 436=“No”), the wireless communication device processor may determine whether there are any remaining acquired radio access technologies in determination block 440. So long as there is at least one remaining acquired radio access technology (i.e., determination block 440=“Yes”), the wireless communication device processor may continue to determine whether the default priority ranking of the next acquired radio access technology is higher than corresponding priority ranking in the RAT priority list for the second SIM in determination block 436. In response to determining that there are no remaining acquired radio access technologies (i.e., determination block 440=“No”), the method 400 may end.

References to first SIM/SIM-1 and second SIM/SIM-2 are arbitrary, and may apply to either or any SIM and/or radio resource of the wireless communication device. For example, various embodiments and claims refer to performing service acquisition for an out-of-service first SIM, and utilizing results to update a RAT priority list for both the first and second SIMs. However, the various embodiments and claims are equally applicable to performing service acquisition on an out-of-service second SIM. Further, reference to the second SIM in various embodiments may be for one or multiple SIMs other than the first SIM, depending on the configuration of the wireless communication device. In addition, such designations of SIMs and/or radio resources may be switched or reversed between instances of executing the methods herein.

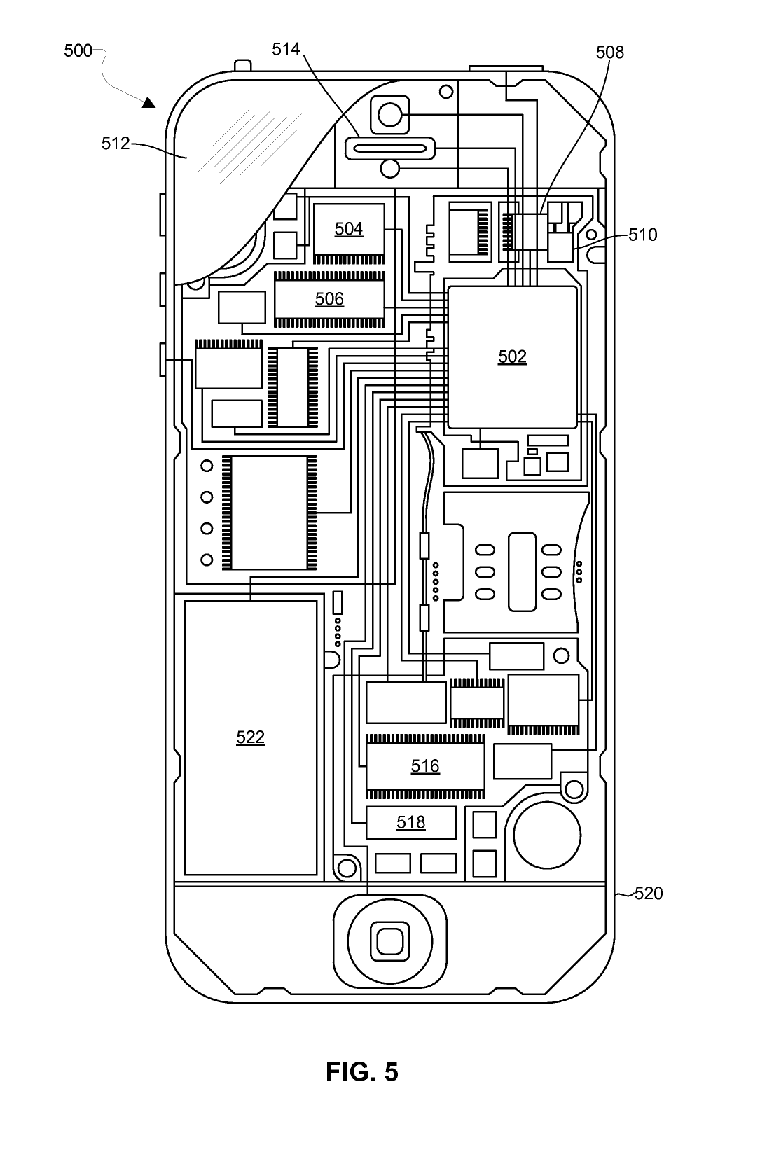

Various embodiments (including, but not limited to, the embodiments described with reference to FIGS. 4A-4C) may be implemented in any of a variety of wireless communication devices, an example 500 of which is illustrated in FIG. 5. With reference to FIGS. 1-5, the wireless communication device 500 (which may correspond, for example, to the wireless communication devices 102 and/or 200 in FIGS. 1-3) may include a processor 502 coupled to a touchscreen controller 504 and an internal memory 506. The processor 502 may be one or more multicore ICs designated for general or specific processing tasks. The internal memory 506 may be volatile or non-volatile memory, and may be secure and/or encrypted memory, or unsecure and/or unencrypted memory, or any combination thereof.

The touchscreen controller 504 and the processor 502 may also be coupled to a touchscreen panel 512, such as a resistive-sensing touchscreen, capacitive-sensing touchscreen, infrared sensing touchscreen, etc. The wireless communication device 500 may have one or more radio signal transceivers 508 (e.g., Peanut®, Bluetooth®, ZigBee®, Wi-Fi, RF radio) and antennas 510, for sending and receiving, coupled to each other and/or to the processor 502. The transceivers 508 and antennas 510 may be used with circuitry in various embodiments to implement various wireless transmission protocol stacks and interfaces. The wireless communication device 500 may include a cellular network wireless modem chip 516 that enables communication via a cellular network and is coupled to the processor. The wireless communication device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless communication device 500 may also include speakers 514 for providing audio outputs. The wireless communication device 500 may also include a housing 520, constructed of a plastic, metal, or a combination of materials, for containing all or some of the components discussed herein. The wireless communication device 500 may include a power source 522 coupled to the processor 502, such as a disposable or rechargeable battery. The rechargeable battery may also be coupled to the peripheral device connection port to receive a charging current from a source external to the wireless communication device 500.

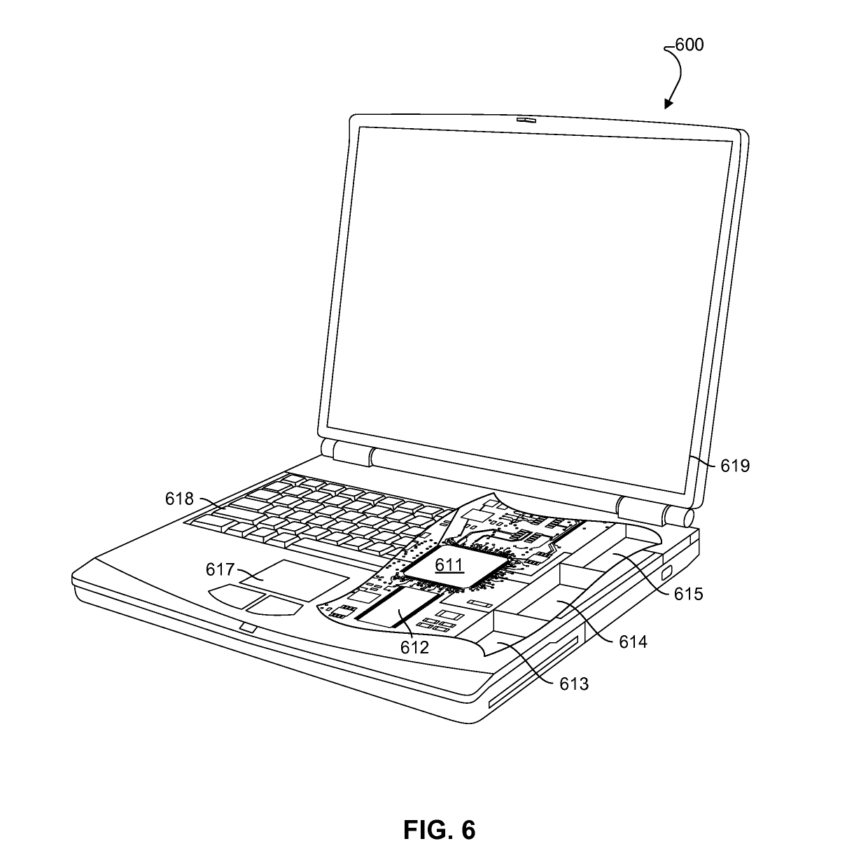

Various embodiments (including, but not limited to, the embodiments discussed with reference to FIGS. 4A-4C), may also be implemented within a variety of personal computing devices, an example 600 of which is illustrated in FIG. 6. With reference to FIGS. 1-6, the laptop computer 600 (which may correspond, for example, to the wireless communication devices 102, 200 in FIGS. 1-3) may include a touchpad touch surface 617 that serves as the computer's pointing device, and thus may receive drag, scroll, and flick gestures similar to those implemented on wireless computing devices equipped with a touchscreen display as described. A laptop computer 600 will typically include a processor 611 coupled to volatile memory 612 and a large capacity nonvolatile memory, such as a disk drive 613 of Flash memory. The computer 600 may also include a floppy disc drive 614 and a compact disc (CD) drive 615 coupled to the processor 611. The computer 600 may also include a number of connector ports coupled to the processor 611 for establishing data connections or receiving external memory devices, such as a universal serial bus (USB) or FireWire® connector sockets, or other network connection circuits for coupling the processor 611 to a network. In a notebook configuration, the computer housing includes the touchpad 617, the keyboard 618, and the display 619 all coupled to the processor 611. Other configurations of the computing device may include a computer mouse or trackball coupled to the processor (e.g., via a USB input) as are well known, which may also be used in conjunction with various embodiments.

With reference to FIGS. 1-6, the processors 502 and 611 may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory 506, 612 and 613 before they are accessed and loaded into the processors 502 and 611. The processors 502 and 611 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 502, 611, including internal memory or removable memory plugged into the device and memory within the processor 502 and 611, themselves.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of various embodiments are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing service acquisition on a wireless communication device having at least a first subscriber identification module (SIM) associated with a radio frequency (RF) resource, comprising:
detecting an out-of-service condition on the first SIM;
identifying, in a first radio access technology priority list (RAT priority list) corresponding to the first SIM, a highest priority radio access technology configured to support the first SIM;
searching for networks associated with the identified radio access technology;
determining whether any network associated with the identified radio access technology is available; and
updating the first RAT priority list in response to determining that no network associated with the identified radio access technology is available.

2. The method of claim 1, further comprising:
creating the first RAT priority list based on a default radio access technology (default RAT) list associated with the first SIM.

3. The method of claim 1, wherein:
searching for networks associated with the identified radio access technology comprises scanning frequencies allocated to the identified radio access technology for channels that satisfy a signal strength threshold; and
determining whether any network associated with the identified radio access technology is available is based on system information read from channels that satisfy the signal strength threshold.

4. The method of claim 1, wherein updating the first RAT priority list comprises:
incrementing a counter associated with the identified radio access technology;
determining whether a current value of the counter is greater than a threshold value corresponding to the identified radio access technology; and
decreasing a priority ranking of the identified radio access technology in the first RAT priority list in response to determining that the current value of the counter is greater than the threshold value.

5. The method of claim 4, wherein the threshold value corresponding to the identified radio access technology is set by the wireless communication device based on signal conditions in a local wireless environment.

6. The method of claim 4, wherein decreasing the priority ranking of the identified radio access technology in the first RAT priority list comprises one of:
lowering the priority ranking of the identified radio access technology by a preset amount; and
changing the priority ranking of the identified radio access technology to a last position in the first RAT priority list.

7. The method of claim 1, further comprising:
determining whether the wireless communication device is configured with a second SIM;
accessing a second RAT priority list corresponding to the second SIM in response to determining that the wireless communication device is configured with the second SIM;
determining whether the identified radio access technology is listed in the second RAT priority list; and
updating the second RAT priority list in response to determining that the identified radio access technology is listed in the second RAT priority list.

8. The method of claim 1, further comprising, in response to determining that at least one network associated with the identified radio access technology is available:
determining whether a mode selection setting for the first SIM requires searching for networks associated with at least one additional radio access technology; and
selecting and registering for service in one of the at least one network available for the identified radio access technology in response to determining that the mode selection setting of the first SIM does not require searching for networks associated with at least one additional radio access technology, wherein registering for service enables communications using a modem stack associated with the first SIM.

9. The method of claim 8, further comprising, in response to determining that the mode selection setting of the first SIM requires searching for networks associated with at least one additional radio access technology:
performing the required searching;
reporting at least one available network associated with the identified radio access technology in combination with any available networks associated with the at least one additional radio access technology; and
receiving input to select and register for service in a reported network, wherein registering for service enables communications using the modem stack associated with the first SIM.

10. The method of claim 8, further comprising:
retrieving information from a first default radio access technology list (default RAT list) associated with the first SIM;
determining, based on the retrieved information, whether a default priority ranking of the identified radio access technology is higher than a current priority ranking of the identified radio access technology in the first RAT priority list; and
replacing the current priority ranking of the identified radio access technology in the first RAT priority list with the default priority ranking in response to determining that the default priority ranking is higher than the current priority ranking.

11. The method of claim 8, further comprising:
retrieving information from a first default radio access technology list (default RAT list) associated with the first SIM;
determining, based on the retrieved information, whether a default priority ranking of any radio access technology associated with a reported network is higher than a corresponding current priority ranking in the first RAT priority list; and
replacing the corresponding current priority ranking in the first RAT priority list with the default priority ranking of that radio access technology in response to determining that the default priority ranking is higher than the corresponding current priority ranking.

12. A wireless communication device, comprising:
a memory;
a radio frequency (RF) resource; and
a processor coupled to the memory and the RF resource, configured to connect to at least a first subscriber identification module (SIM), and configured with processor-executable instructions to:
detect an out-of-service condition on the first SIM;
identify, in a first radio access technology priority list (RAT priority list) corresponding to the first SIM, a highest priority radio access technology configured to support the first SIM;
search for networks associated with the identified radio access technology;
determine whether any network associated with the identified radio access technology is available; and
update the first RAT priority list in response to determining that no network associated with the identified radio access technology is available.

13. The wireless communication device of claim 12, wherein the processor is further configured with processor-executable instructions to:
create the first RAT priority list based on a default radio access technology list (default RAT list) associated with the first SIM.

14. The wireless communication device of claim 12, wherein the processor is further configured with processor-executable instructions to:
search for networks associated with the identified radio access technology by scanning frequencies allocated to the identified radio access technology for channels that satisfy a signal strength threshold; and
determine whether any network associated with the identified radio access technology is available is based on system information read from channels that satisfy the signal strength threshold.

15. The wireless communication device of claim 12, wherein the processor is further configured with processor-executable instructions to update the first RAT priority list by:
incrementing a counter associated with the identified radio access technology;
determining whether a current value of the counter is greater than a threshold value corresponding to the identified radio access technology; and
decreasing a priority ranking of the identified radio access technology in the first RAT priority list in response to determining that the current value of the counter is greater than the threshold value.

16. The wireless communication device of claim 15, wherein the threshold value corresponding to the identified radio access technology is set by the wireless communication device based on signal conditions in a local wireless environment.

17. The wireless communication device of claim 15, wherein the processor is further configured with processor-executable instructions to decrease the priority ranking of the identified radio access technology in the first RAT priority list by performing one of:
lowering the priority ranking of the identified radio access technology by a preset amount; and
changing the priority ranking of the identified radio access technology to a last position in the first RAT priority list.

18. The wireless communication device of claim 12, wherein the processor is further configured with processor-executable instructions to:
determine whether the wireless communication device is configured with a second SIM;
access a second RAT priority list corresponding to the second SIM in response to determining that the wireless communication device is configured with a second SIM;
determine whether the identified radio access technology is listed in the second RAT priority list; and
update the second RAT priority list in response to determining that the identified radio access technology is listed in the second RAT priority list.

19. The wireless communication device of claim 12, wherein the processor is further configured with processor-executable instructions to, in response to determining that at least one network associated with the identified radio access technology is available:
determine whether a mode selection setting for the first SIM requires searching for networks associated with at least one additional radio access technology; and
select and register for service in one of the at least one network available for the identified radio access technology in response to determining that the mode selection setting of the first SIM does not require searching for networks associated with at least one additional radio access technology, wherein registering for service enables communications using a modem stack associated with the first SIM.

20. The wireless communication device of claim 19, wherein the processor is further configured with processor-executable instructions to, in response to determining that the mode selection setting of the first SIM requires searching for networks associated with at least one additional radio access technology:
perform the required searching;
report at least one available network associated with the identified radio access technology in combination with any available networks associated with the at least one additional radio access technology; and
receive input to select and register for service in a reported network, wherein registering for service enables communications using the modem stack associated with the first SIM.

21. The wireless communication device of claim 19, wherein the processor is further configured with processor-executable instructions to:
retrieve information from a first default radio access technology list (default RAT list) associated with the first SIM;
determine, based on the retrieved information, whether a default priority ranking of the identified radio access technology is higher than a current priority ranking of the identified radio access technology in the first RAT priority list; and
replace the current priority ranking of the identified radio access technology in the first RAT priority list with the default priority ranking in response to determining that the default priority ranking is higher than the current priority ranking of the identified radio access technology.

22. The wireless communication device of claim 19, wherein the processor is further configured with processor-executable instructions to:
retrieve information from a first default radio access technology list (default RAT list) associated with the first SIM;
determine, based on the retrieved information, whether a default priority ranking of any radio access technology associated with a reported network is higher than a corresponding current priority ranking in the first RAT priority list; and
replace the corresponding current priority ranking in the first RAT priority list with the default priority ranking of that radio access technology in response to determining that the default priority ranking is higher than the corresponding current priority ranking.

23. A wireless communication device, comprising:
a radio frequency (RF) resource;
means for detecting an out-of-service condition on a first subscriber identification module (SIM);
means for identifying, in a first radio access technology priority list (RAT priority list) corresponding to the first SIM, a highest priority radio access technology configured to support the first SIM;
means for searching for networks associated with the identified radio access technology;
means for determining whether any network associated with the identified radio access technology is available; and
means for updating the first RAT priority list in response to determining that no network associated with the identified radio access technology is available.

24. A non-transitory processor-readable storage medium having stored thereon processor-executable instructions configured to cause a processor of a wireless communication device to perform operations comprising:
detecting an out-of-service condition on a first subscriber identification module (SIM);
identifying, in a first radio access technology priority list (RAT priority list) corresponding to the first SIM, a highest priority radio access technology configured to support the first SIM;
searching for networks associated with the identified radio access technology;
determining whether any network associated with the identified radio access technology is available; and
updating the first RAT priority list in response to determining that no network associated with the identified radio access technology is available.

25. The non-transitory processor-readable storage medium of claim 24, wherein the stored processor-executable instructions are configured to cause the processor of the wireless communication device to perform operations further comprising:
creating the first RAT priority list based on a default radio access technology list (default RAT list) associated with the first SIM.

26. The non-transitory processor-readable storage medium of claim 24, wherein the stored processor-executable instructions are configured to cause the processor of the wireless communication device to perform operations such that:
searching for networks associated with the identified radio access technology comprises scanning frequencies allocated to the identified radio access technology for channels that satisfy a signal strength threshold; and
determining whether any network associated with the identified radio access technology is available is based on system information read from channels that satisfy the signal strength threshold.

27. The non-transitory processor-readable storage medium of claim 24, wherein the stored processor-executable instructions are configured to cause the processor of the wireless communication device to perform operations such that updating the first RAT priority list comprises:
incrementing a counter associated with the identified radio access technology;
determining whether a current value of the counter is greater than a threshold value corresponding to the identified radio access technology; and
decreasing a priority ranking of the identified radio access technology in the first RAT priority list in response to determining that the current value of the counter is greater than the threshold value.
